(19) United States
(12) Patent Application Publication
(10) Pub. No.: US 2019/0017253 A1
(43) Pub. Date: Jan. 17, 2019

(54) WATER PRESSURE BALANCE ASSEMBLY AND VALVE CORE WITH SAME

(71) Applicants: Xianbing SHI, Kaiping City (CN); Junfa SHEN, Kaiping City (CN)

(72) Inventors: Xianbing SHI, Kaiping City (CN); Junfa SHEN, Kaiping City (CN)

(21) Appl. No.: 15/646,650

(22) Filed: Jul. 11, 2017

(51) Int. Cl. E03C 1/04; G05D 23/13

(52) U.S. Cl. CPC E03C 1/041; E03C 2201/30; G05D 23/1313; E03C 1/0408

(57) ABSTRACT

Disclosed is a water pressure balance assembly comprising a water-passing member provided with a hot water hole through which hot water passes and a cold water hole through which cold water passes, and a water-stopping member housed within the water-passing member The water-stopping member is provided with a first and second water-passing sections corresponding to the hot and cold water holes respectively. A partition is provided between the first and second water-passing sections, wherein the first and second water-stopping sections are provided respectively outward of the first and second water-passing sections. The hot or cold water holes can be occluded completely or partially by the first and second water-stopping sections through movement of the water-stopping member. The water-passing and/or water-stopping members are/is made of ceramic material. A valve core with the water pressure balance assembly above is further provided.

### TECHNICAL FIELD

The disclosure relates to the field of valve, and in particular to a water pressure balance assembly and a valve core with same.

### BACKGROUND

In daily life, when using the faucet, water pressure may be instable due to factors such as the sudden shut-down of water, changes in water pressure. One may be scalded when the water temperature is too high or may catch cold when the water temperature is too low. The control of the outlet water temperature is mainly dependent on a valve core installed inside the faucet. The existing valve core is mainly divided into two types, wherein, one is the valve core without water pressure balance assembly, which cannot balance the cold water pressure and the hot water pressure, thus being incapable of solving the problem above; the other can automatically balance the cold water pressure and hot water pressure in a short time to keep the outlet water temperature stable. However, water pressure balance assembly of such valve core comprising a stainless water-passing member and a stainless water-stopping member will easily form scale due to the frequency movement of water-stopping member and the water quality problems, and accordingly the water-passing member and water-stopping member can easily get stuck by scale, thereby losing their regulation function.

### SUMMARY

The disclosure is intended to solve, at least to a certain extent, one of the above-mentioned technical problems in the related art by providing a water pressure balance assembly and a valve core with the water pressure balance assembly. The water pressure balance assembly is made of ceramic, which rarely generates scale, thereby effectively extending the service life. A constant outlet water temperature can also be achieved by the valve core with the water pressure balance assembly.

To solve the technical problem, it provides a water pressure balance assembly comprising: a water-passing member provided with a hot water hole through which hot water passes and a cold water hole through which cold water passes; and a water-stopping member housed within the water-passing member, the water-stopping member is provided with a first water-passing section and a second water-passing section corresponding to the hot water hole and the cold water hole respectively, a partition is provided between the first water-passing section and the second water-passing section, a first water-stopping section and a second water-stopping section are provided respectively outward of the first water-passing section and the second water-passing section; wherein the hot water hole or cold water hole can be occluded completely or partially by the first water-stopping section and the second water-stopping section through movement of the water-stopping member, and wherein the water-passing member and/or the water-stopping member are made of ceramic material.

Further, the first water-stopping section and the second water-stopping section are connected to the partition by a plurality of connecting posts between which the first water-passing section and the second water-passing section are formed.

Further, each of the plurality of connecting posts is provided with at least one guide ramp for facilitating flow of water.

Further, the water-passing member is provided with a plurality of recesses on an outer surface thereof for mounting a sealed ring.

A valve core with the water pressure balance assembly described above, further comprising: a housing assembly, a valve core assembly within the housing assembly and a control assembly for controlling operation of the valve core assembly.

Further, the housing assembly comprises a valve housing, a cap above the valve housing and a base below the valve housing, the base is provided with a hot water inlet and a cold water inlet in communication with the hot water hole and the cold water hole respectively.

Further, the valve core assembly comprises a valve body provided within the valve housing, the valve body comprises a cavity for receiving the water pressure balance assembly, a hot water outlet and a cold water outlet in communication with the hot water hole and the cold water hole respectively.

Further, the control assembly comprises a rotating disc rotatably provided within the cap, the rotating disc is provided with a hot water through-hole groove and a cold water through-hole groove corresponding to the hot water outlet and the cold water outlet respectively, the rotating disc is connected to a handle for driving its rotation.

Further, the valve housing is provided with a hot water passage in communication with the hot water outlet and the hot water through-hole groove, and a cold water passage in communication with the cold water outlet and the cold water through-hole groove, within the hot water passage and the cold water passage are both provided with a spring and a sealed ring at one end of the spring and abutting against a lower bottom surface of the rotating disc.

Further, the valve housing is provided with a water outlet in communication with the hot water through-hole groove and the cold water through-hole groove.

Further, the cap is provided with an insulating lip at an upper end thereof.

The disclosure has the following advantages: in the water pressure balance assembly, the water-passing member and/or water-stopping member are/is made of ceramic, with no fear of any water quality and little generation of scale, thereby avoiding the water-passing member and water-stopping member to get stuck and effectively extending service life of the water pressure balance assembly; the valve core with the water pressure assembly described above, which is capable of achieving a pressure balance between cold water and hot water in a short time, ensures the stability of water temperature, and better satisfies the user experience.

### BRIEF DESCRIPTION OF THE DRAWINGS

The embodiments of the disclosure will now be further described with reference to the accompanying drawings, wherein:

FIG. 1 is a schematic structural view of a water pressure balance assembly according to the disclosure;

FIG. 2 is a schematic view showing the explosion structure of a valve core according to the disclosure; and

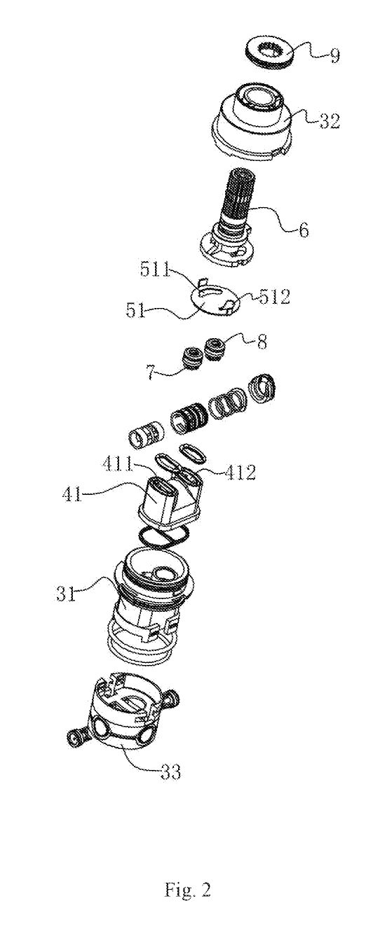

FIG. 3 is a schematic cross-sectional view of the valve core according to the disclosure.

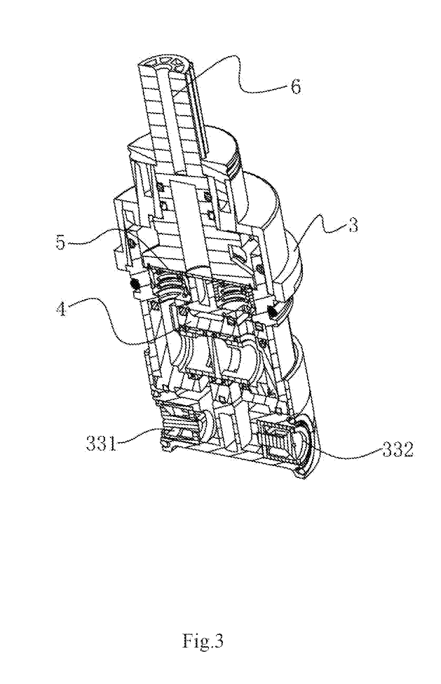

### DETAILED DESCRIPTION

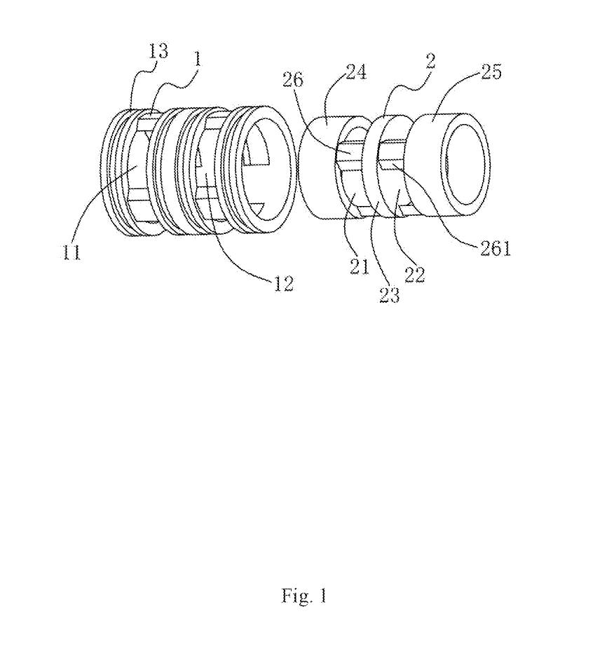

Referring to FIG. 1, the disclosure provides a water pressure balance assembly comprising a water-passing member 1 provided with a hot water hole 11 through which hot water passes and a cold water hole 12 through which cold water passes, and a water-stopping member 2 housed within the water-passing member 1, wherein: the water-stopping member 2 comprises a first water-passing section 21 and a second water-passing section 22 corresponding to the hot water hole 11 and the cold water hole 12 respectively; a partition 23 is provided between the first water-passing section 21 and the second water-passing section 22; and a first water-stopping section 24 and a second water-stopping section 25 are provided respectively outward of the first water-passing section 21 and the second water-passing section 22. The hot water hole 11 or cold water hole 12 can be occluded completely or partially by the first water-stopping section 24 and the second water-stopping section 25 through movement of the water-stopping member 2, and the water-passing member 1 and/or the water-stopping member 2 are/is made of ceramic material.

In use, hot water and cold water enter from the hot water hole 11 and the cold water hole 12 respectively and are respectively filled at both ends of the partition 2. Water will flow towards a side with lower pressure if pressures at both sides of the partition 23 are not equal, thereby causing the first water-stopping section 24 or the second water-stopping section 25 to occlude the hot water hole 11 or cold water hole 12 to regulate water pressures, and the hot water pressure and cold water pressure will always be maintained balanced to ensure a constant outlet water temperature. For example, if there is a smaller amount of hot water, the pressure at the hot water side of the partition 23 will be smaller, and the water-stopping member 2 will move towards the hot water side under a pressure difference, causing the second water-stopping section 25 to gradually increase area occluding the cold water hole 12 to decrease the cold water amount and thereby to decrease pressure at the cold water side of the partition 23 while causing the first water-stopping section 24 to gradually decrease area occluding the hot water hole 11 to increase the hot water amount and thereby to increase pressure at the hot water side of the partition 23, finally achieving a balance between pressures at both sides of the partition 23. In a special embodiment, for example, there is no hot water suddenly, then the water-stopping member 2 will move towards the hot water side rapidly until the second water-stopping section 25 occludes completely the cold water hole 12. Cold water will not be discharged at this time, thereby avoiding damage to the human body because of sudden changes in water temperature. In a preferred embodiment, the water-passing member 1 and water-stopping member 2 may both be made of ceramic material, which greatly reduces the scale generation and extends the service life of the water pressure balance assembly. In other embodiments, either the water-passing member 1 or the water-stopping member 2 may be made of ceramic material, and the scale generation may also be effectively reduced. In addition, the wear resistance of the water-passing member 1 and water-stopping member 2 may be ensured by use of ceramic material.

Further, the first water-stopping section 24 and the second water-stopping section 25 are connected to the partition 23 by a plurality of connecting posts 26 between which the first water-passing section 21 and the second water-passing section 22 are formed. Each of the plurality of connecting posts is provided with at least one guide ramp 261 for facilitating flow of water.

Further, the water-passing member 1 is provided with a plurality of recesses 13 on an outer surface thereof for mounting a sealed ring.

Further, an outer wall of the water-stopping member 2 is in close contact with an inner wall of the water-passing member 1 such that water pressures at both sides of the partition 23 are actual cold water pressure and hot water pressure respectively, thereby ensuring the accuracy of homeothermy regulation by the water pressure balance assembly.

Further, the water-passing member 1 is provided with a stopper at both ends for limiting the water-stopping member 2. The stopper may limit movement of the water-stopping member 2. Stoppers at both ends correspond respectively to two limit positions between which the water-stopping member 2 moves, i.e., two states in one of which the first water-stopping section 24 occludes completely the hot water hole 11 and in the other one of which the second water-stopping section 25 occludes completely the cold water hole 12.

The disclosure further provides a valve core with the water pressure assembly described above, further comprising a housing assembly 3, a valve core assembly 4 within the housing assembly 3 and a control assembly 5 for controlling operation of the valve core assembly 4.

Further, the housing assembly 3 comprises a valve housing 31, a cap 32 above the valve housing 31 and a base 33 below the valve housing 31, wherein the base 33 is provided with a hot water inlet 331 and a cold water inlet 332 in communication with the hot water hole 11 and the cold water hole 12 respectively. In this embodiment, the valve housing 31 is connected with the cap 32 and the base 33 by a snap-fit connection, which facilitates machining and disassembly. However, this is just a preferred embodiment, in other embodiments, removable connection such as bolts may also be used. In addition, in this embodiment, the hot water inlet 331 and the cold water inlet 332 in the base 33 are each further provided with a check valve to prevent backflow.

Further, the valve core assembly 4 comprises a valve body 41 provided within the valve housing 31, wherein the valve body 41 comprises a cavity for receiving the water pressure balance assembly, a hot water outlet 411 and a cold water outlet 412 in communication with the hot water hole 11 and the cold water hole 12 respectively.

Still further, the control assembly 5 comprises a rotating disc 51 rotatably provided within the cap 32, wherein the rotating disc 51 is provided with a hot water through-hole groove 511 and a cold water through-hole groove 512 corresponding to the hot water outlet 411 and the cold water outlet 412 respectively, the rotating disc 51 is engaged with a handle 6 for driving its rotation. The rotating disc 51 rotates with rotation of the handle 6 so as to realize regulation of communication areas between the hot water through-hole groove 511 and the hot water outlet 411 and between the cold water through-hole groove 512 and the cold water outlet 412, thereby realizing regulation of ratio of cold water to hot water in mixed water, and finally realizing water temperature regulation.

Still further, the valve housing 31 is provided with a hot water passage in communication with the hot water outlet 411 and the hot water through-hole groove 511, and a cold water passage in communication with the cold water outlet 412 and the cold water through-hole groove 512, within the hot water passage and the cold water passage are both provided with a spring 7 and a sealed ring 8 at one end of the spring 7 and abutting against a lower bottom surface of the rotating disc 51. The arrangement of the spring 7 allows the sealed ring 8 to abut against the lower bottom surface of the rotating disc 51 to ensure that the outlet water amount is entirely determined by the size of the communication area and ensure the accuracy of water temperature regulation.

Further, the valve housing 31 is provided with a water outlet in communication with the hot water through-hole groove 511 and the cold water through-hole groove 512. Hot water and cold water are mixed and discharged from the water outlet.

Further, the cap 32 is provided with an insulating lip 9 at an upper end thereof. The insulating lip 9 may prevent the operator from being burned by the housing assembly 3.

Operation process of the valve core is accomplished mainly by two lines, i.e., cold water line and hot water line: hot water enters from the hot water inlet 331 of the base 33, and flows out from the hot water outlet 411 to the hot water passage after the hot water pressure is balanced by the water pressure balance assembly, then flows out from the hot water through-hole groove 511 and into the cap 32; cold water enters from the cold water inlet 332 of the base 33, and flows out from the cold water outlet 412 to the hot water passage after the cold water pressure is balanced by the water pressure balance assembly, then flows out from the cold water through-hole groove 512 and into the cap 32. Cold water and hot water in the cap 32 are mixed and discharged from the water outlet.

In the above embodiments, two regulation processes are described as follows: one is automatic regulation on hot water pressure and cold water pressure by the water pressure balance assembly, and the other is manual regulation on the rotating disc 51 to achieve regulation of amounts of hot water and cold water. Through combination of the two regulations, adaptive regulation on water temperature can be achieved, and the regulated water may flow out in a constant temperature.

The above specific structures and size data are for detailed description of the preferred embodiments of the disclosure, however, the disclosure is not limited to the embodiments, and it will be apparent to those skilled in the art that various equivalent variations or replacements may be made without departing from the spirit of the disclosure, these equivalent variations or substitutions are included within the scope of the disclosure as defined by the appended claims.

1. A water pressure balance assembly comprising:
a water-passing member provided with a hot water hole through which hot water passes and a cold water hole through which cold water passes; and
a water-stopping member housed within the water-passing member,
wherein the water-stopping member is provided with a first water-passing section and a second water-passing section corresponding to the hot water hole and the cold water hole respectively, a partition is provided between the first water-passing section and the second water-passing section, a first water-stopping section and a second water-stopping section are provided respectively outward of the first water-passing section and the second water-passing section,
wherein the hot water hole or cold water hole can be occluded completely or partially by the first water-stopping section and the second water-stopping section through movement of the water-stopping member, and wherein the water-passing member and/or the water-stopping member are/is made of ceramic material.

2. The water pressure balance assembly according to claim 1, wherein the first water-stopping section and the second water-stopping section are connected to the partition by a plurality of connecting posts between which the first water-passing section and the second water-passing section are formed.

3. The water pressure balance assembly according to claim 2, wherein each of the plurality of connecting posts is provided with at least one guide ramp for facilitating flow of water.

4. The water pressure balance assembly according to claim 1, wherein the water-passing member is provided with a plurality of recesses on an outer surface thereof for mounting a sealed ring.

5. A valve core having the water pressure balance assembly according to claim 1, further comprising:
a housing assembly;
a valve core assembly within the housing assembly; and
a control assembly for controlling operation of the valve core assembly.

6. The valve core according to claim 5, wherein the housing assembly comprises a valve housing, a cap above the valve housing and a base below the valve housing, the base is provided with a hot water inlet and a cold water inlet in communication with the hot water hole and the cold water hole respectively.

7. The valve core according to claim 5, wherein the valve core assembly comprises a valve body provided within the valve housing, the valve body comprises a cavity for receiving the water pressure balance assembly, a hot water outlet and a cold water outlet in communication with the hot water hole and the cold water hole respectively.

8. The valve core according to claim 6, wherein the control assembly comprises a rotating disc rotatably provided within the cap, the rotating disc is provided with a hot water through-hole groove and a cold water through-hole groove corresponding to the hot water outlet and the cold water outlet respectively, the rotating disc is connected to a handle for driving its rotation.

9. The valve core according to claim 8, wherein the valve housing is provided with a hot water passage in communication with the hot water outlet and the hot water through-hole groove, and a cold water passage in communication with the cold water outlet and the cold water through-hole groove, within the hot water passage and the cold water passage are both provided with a spring and a sealed ring at one end of the spring and abutting against a lower bottom surface of the rotating disc.

10. The valve core according to claim 8, wherein the valve housing is provided with a water outlet in communication with the hot water through-hole groove and the cold water through-hole groove.

11. The water pressure balance assembly according to claim 2, wherein the water-passing member is provided with a plurality of recesses on an outer surface thereof for mounting a sealed ring.
